(19) United States
(12) Patent Application Publication
(10) Pub. No.: US 2025/0243766 A1
(43) Pub. Date: Jul. 31, 2025

(54) POLYMER-METAL COMPOSITE STATOR VANES AND METHODS FOR MANUFACTURING THE SAME

(71) Applicant: HONEYWELL INTERNATIONAL INC., Charlotte, NC (US)

(72) Inventors: Tirumala Rao Koka, Banalore (IN); Costas Vogiatzis, Phoenix, AZ (US); Dmytro Dmytrenko, Phoenix, AZ (US); Cheikh Cisse, Phoenix, AZ (US); Kaitlyn Holmstrom, Torrance, CA (US); Balakumaran Natarajan, Bangalore (IN); Yoseph Gebre-Giorgis, Phoenix, AZ (US)

(73) Assignee: HONEYWELL INTERNATIONAL INC., Charlotte, NC (US)

(21) Appl. No.: 18/605,370

(22) Filed: Mar. 14, 2024

(30) Foreign Application Priority Data
Jan. 31, 2024 (IN) 202411006409

(51) Int. Cl. F01D 5/28; B29C 45/14; B29C 45/34; B29K 705/00; B29L 31/08

(52) U.S. Cl. CPC F01D 5/28; B29C 45/14065; B29C 45/34; B29C 2045/14155; B29K 2705/00; B29L 2031/08; F05D 2230/20

(57) ABSTRACT

Stator vanes for gas turbine engines and methods of producing the same are provided. The stator vanes include a body configured to be installed in a bypass of the gas turbine engine such that the body impinges a gas flow within the gas turbine engine during operation thereof. The body has a suction side wall configured to face away from the incoming gas flow and an oppositely disposed pressure side wall configured to face towards the incoming gas flow. The body includes a polymeric substrate formed of a polymer material and a metallic sheet formed of a metallic material. The metallic sheet covers a portion of the polymeric substrate and is at least partially embedded in the polymeric substrate. The polymeric substrate is formed by an injection molding process.

### CROSS REFERENCE TO RELATED APPLICATION

This application claims priority to India Provisional Patent Application No. 202411006409, filed Jan. 31, 2024, the entire content of which is incorporated by reference herein.

### TECHNICAL FIELD

The present invention generally relates to gas turbine engines, and more particularly relates to polymer-metal composite stator vanes and methods of manufacturing such stator vanes.

### BACKGROUND

Gas turbine engine fan stators are static components used to straighten a flow of compressed air generated by fan blades prior to the flow entering the outer bypass duct and stages of a compressor core. The stators are required to withstand various structural loads including certain thermal, aerodynamic, and foreign object damage (FOD) loading conditions. These structural requirements are typically achieved by forming the vanes of the stators from composite materials (e.g., carbon fiber composites). However, common manufacturing processes are human dependent and therefore often have relatively high rejection rates due to unmet design tolerances.

Hence, there is a need for improved stator construction processes that provide desired structural properties while capable of being manufactured with improved conformity to design tolerances. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a stator vane is provided for a gas turbine engine that includes a body configured to be installed in a bypass of the gas turbine engine such that the body impinges a gas flow within the gas turbine engine during operation thereof. The body has a suction side wall configured to face away from the incoming gas flow and an oppositely disposed pressure side wall configured to face towards the incoming gas flow. The body includes a polymeric substrate formed of a polymer material and a metallic sheet formed of a metallic material. The metallic sheet covers a portion of the polymeric substrate and is at least partially embedded in the polymeric substrate. The polymeric substrate is formed by an injection molding process.

In various embodiments, a method of manufacturing a stator vane for a gas turbine engine is provided that includes forming a metallic sheet of a metallic material, locating the metallic sheet in a cavity of a mold, wherein the mold includes one or more vents in fluidic communication with the metallic sheet, generating low pressure or vacuum conditions within the one or more vents of the mold to generate a suction force on the metallic sheet and thereby secure the metallic sheet against an interior wall of the mold, and performing an injection molding process to inject a polymeric material into the mold and thereby form a polymeric substrate that is fixed to the metallic sheet. The metallic sheet covers a portion of the polymeric substrate and is at least partially embedded in the polymeric substrate. The polymeric substrate and the metallic sheet in combination define a body of the stator vane configured to be installed in a bypass of the gas turbine engine such that the body impinges a gas flow within the gas turbine engine during operation thereof, the body having a suction side wall configured to face away from the incoming gas flow and an oppositely disposed pressure side wall configured to face towards the incoming gas flow.

Furthermore, other desirable features and characteristics of the stator vane and the method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a gas turbine engine in accordance with an embodiment;

FIGS. 2-7 schematically represent examples of stator vanes in accordance with various embodiments; and

FIG. 8 is a flowchart illustrating an exemplary method for manufacturing stator vanes in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Briefly, polymer-metal composite stator vanes for use in gas turbine engines and methods for provide for production thereof are disclosed herein. The stator vanes are capable of providing structural properties similar to and/or better than existing composite stator vanes while capable of being manufactured with improved conformity to design tolerances. The stator vanes are configured to withstand various thermal, aerodynamic, and foreign object damage (FOD) loading conditions that may be experienced within a gas turbine engine.

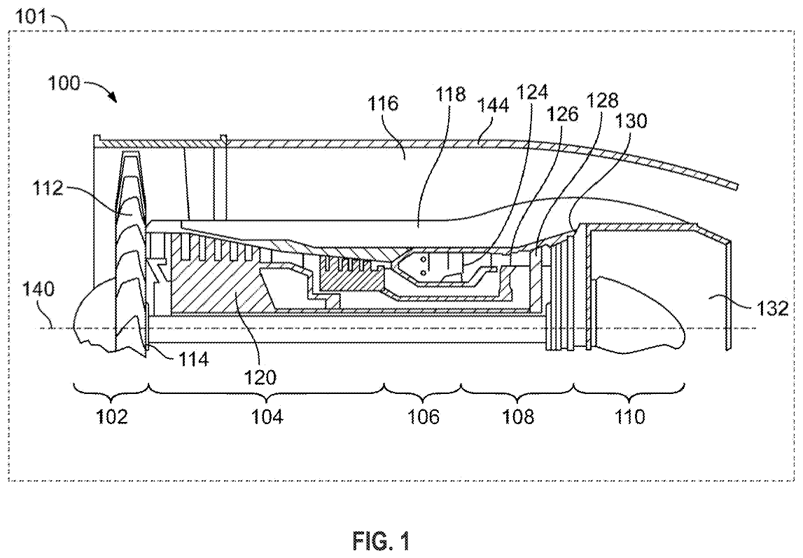

With reference to FIG. 1, a partial, cross-sectional view of an exemplary gas turbine engine 100 is shown with the remaining portion of the gas turbine engine 100 being substantially axisymmetric about a longitudinal axis 140, which also defines an axis of rotation for the gas turbine engine 100. In the depicted embodiment, the gas turbine engine 100 is an annular multi-spool turbofan gas turbine jet engine within an aircraft (represented schematically at 101), although features of the present disclosure may be included in other configurations, arrangements, and/or uses. For example, in other embodiments, the gas turbine engine 100 may assume the form of a non-propulsive engine, such as an Auxiliary Power Unit (APU) deployed onboard the aircraft 101, an industrial power generator, or other turbomachine.

In this example, with continued reference to FIG. 1, the gas turbine engine 100 includes a fan section 102, a compressor section 104, a combustor section 106, a turbine section 108, and an exhaust section 110. In one example, the fan section 102 includes a fan 112 mounted on a rotor 114 that draws air into the gas turbine engine 100 and compresses it. A fraction of the compressed air exhausted from the fan 112 is directed through the outer bypass duct 116 and the remaining fraction of air exhausted from the fan 112 is directed into the compressor section 104. The outer bypass duct 116 is generally defined by an outer casing 144 that is spaced apart from and surrounds an inner bypass duct 118.

In the embodiment of FIG. 1, the compressor section 104 includes one or more compressors 120. The number of compressors 120 in the compressor section 104 and the configuration thereof may vary. The one or more compressors 120 sequentially raise the pressure of the air and direct a majority of the high-pressure fluid or air into the combustor section 106. In the combustor section 106, which includes a combustion chamber 124, the high-pressure air is mixed with fuel and is combusted. The high-temperature combustion air or combustive gas flow is directed into the turbine section 108. In this example, the turbine section 108 includes three turbines disposed in axial flow series, namely, a high-pressure turbine 126, an intermediate pressure turbine 128, and a low-pressure turbine 130. However, it will be appreciated that the number of turbines, and/or the configurations thereof, may vary. In this embodiment, the high-temperature combusted air from the combustor section 106 expands through and rotates each turbine 126, 128, and 130. The combustive gas flow then exits the turbine section 108 for mixture with the cooler bypass airflow from the outer bypass duct 116 and is ultimately discharged from the gas turbine engine 100 through the exhaust section 132. As the turbines 126, 128, 130 rotate, each drives equipment in the gas turbine engine 100 via concentrically disposed shafts or spools.

The engine 100 includes one or more stages of static fan stators configured to direct and/or straighten a flow of the compressed air that comes from the fan 112 prior to entering the outer bypass duct 116 and compressor section 104. In some examples, the fan stators may include a plurality of stator vanes (e.g., airfoils). In various examples, the stator vanes may include a body configured to be installed in a bypass of the gas turbine engine 100 such that the body impinges a gas flow within the engine 100 during operation thereof. The body may have a suction side wall configured to face away from the incoming gas flow and an oppositely disposed pressure side wall configured to face towards the incoming gas flow. The body of the stator vane may be configured to extend between and be secured to a hub and a shroud of the gas turbine engine 100. For example, the stator vanes may include a body having a hub end configured to couple with the hub and an oppositely disposed shroud end configured to couple with the shroud.

One or more of the stator vanes may include or be formed of a polymer-metal composite. In various examples, the polymer-metal composite includes a polymeric substrate or core with a metallic film or sheet disposed thereon or therein. The metallic sheet may be disposed on the pressure side wall, embedded within the polymeric substrate, disposed on the suction side wall, or a combination thereof. The stator vanes may have various shapes and sizes and are not limited to any particular structure. In some examples, the polymeric substrate defines an entirety of the suction side wall and the metallic sheet defines an entirety of the pressure side wall. In some examples, the polymeric substrate defines an entirety of the pressure side wall and the metallic sheet defines an entirety of the suction side wall. In some examples, the polymeric substrate defines an entirety of the suction side wall and the metallic sheet material defines part of but less than an entirety of the pressure side wall. In some examples, the polymeric substrate defines an entirety of the pressure side wall and the metallic sheet material defines part of but less than an entirety of the suction side wall. In some examples, the polymeric substrate defines part of but less than entirety of the pressure side wall and the metallic sheet material defines part of but less than an entirety of the suction side wall.

In examples wherein the metallic sheet is disposed on the polymeric substrate and has exposed outer surfaces, the metallic sheet may be recessed in the polymeric substrate such that outer surfaces of the metallic sheet are substantially flush with adjacent outer surfaces of the polymeric substrate. In various examples, the metallic sheet may have a thickness in the range of 0.005 to 0.009 inches (e.g., 127 to 229 micrometers), such as between 0.006 to 0.008 inches (e.g., 152 to 204 micrometers), such as about 0.007 inches (e.g., 178 micrometers). In some examples, the polymeric substrate forms a majority of the stator vane. In some examples, a cross-sectional thickness of the body of the stator vane includes about 90 to about 95 weight percent of the polymeric substrate and about 1 to 5 weight percent of the metallic sheet. In various examples, the stator vane consists of the polymeric substrate and the metallic sheet.

In various examples, the metal sheet is configured to promote decoupling of the hub end and the shroud end of the stator vane in response to high foreign object damage (FOD) loading (e.g., in excess of a threshold) during operation of the gas turbine engine 100. This functionality is promoted by the superior tensile load taking capability of the metal sheet relative to the polymeric substrate. Thus, during FOD loading conditions, the metal sheet may promote and/or enable decupling of the polymeric substrate at the hub and the shroud.

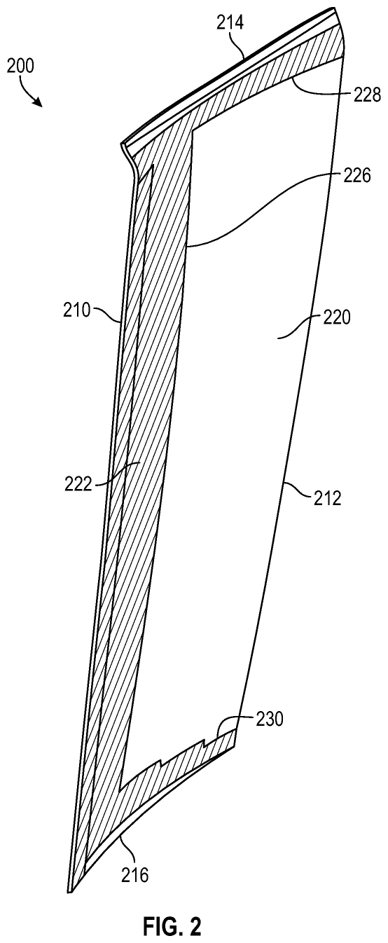

FIGS. 2-7 present exemplary stator vanes, referred to as the first stator vane 200, the second stator vane 300, the third stator vane 400, the fourth stator vane 500, the fifth stator vane 600, and the sixth stator vane 700. In view of similarities between these exemplary stator vanes, the following discussion of the stator vanes will focus primarily on aspects of each of the stator vanes that differ from the previously discussed stator vanes in some notable or significant manner. Other aspects of the stator vanes not discussed in any detail can be, in terms of structure, function, materials, etc., essentially as was described for the previously described stator vane(s). In these figures, consistent reference numbers are used to identify the same or functionally related elements, but with a numerical prefix (1, 2, or 3, etc.) added to distinguish between the particular examples.

Referring to FIG. 2, an exemplary first stator vane 200 is presented. The first stator vane 200 has an airfoil shaped body with a generally concave pressure side, a generally convex suction side, a leading edge 210, a trailing edge 212, a radially outermost edge 214, and a radially innermost edge 216. In this nonlimiting example, the first stator vane 200 includes a polymeric substrate 220 and a metallic sheet 222. The polymeric substrate 220 defines a majority of the body. The metallic sheet 222 covers areas of the polymeric substrate 220 on the suction side wall of the first stator vane 200, including areas at or adjacent to the leading edge 210 (referred to as the leading portion of the metallic sheet 222), the radially outermost edge 214 (referred to as the outer portion of the metallic sheet 222), and the radially innermost edge 216 (referred to as the inner portion of the metallic sheet 222). Areas of the polymeric substrate 220 at or adjacent to a central region of the suction side wall and the trailing edge 212, as well as the pressure side wall of the first stator vane 200, are not covered by the metallic sheet 222.

The leading portion of the metallic sheet 222 extends from the leading edge 210 to a first edge 226 and extends from the radially outermost edge 214 to the radially innermost edge 216. Dimensions of the leading portion measured between the leading edge 210 and the first edge 226 may be equal or may vary along the leading edge 210. The outer portion of the metallic sheet 222 extends from the leading edge 210 to the trailing edge 212 and extends from the radially outermost edge 214 to a second edge 228. Dimensions of the outer portion measured between the radially outermost edge 214 and the second edge 228 may be equal or may vary along the radially outermost edge 214. The inner portion of the metallic sheet 222 extends from the leading edge 210 to the trailing edge 212 and extends from the radially innermost edge 216 to a third edge 230. Dimensions of the inner portion measured between the radially innermost edge 216 and the third edge 230 may be equal or may vary along the radially innermost edge 216.

The first edge 226, the second edge 228, and the third edge 230 may each have various paths or profiles. In the example of FIG. 2, the first edge 226 and the second edge 228 are substantially linear. In contrast, the third edge 230 defines a stepped path or profile wherein dimensions of the inner portion measured between the radially innermost edge 216 and the third edge 230 incrementally decrease toward the trailing edge 212 of the first stator vane 200.

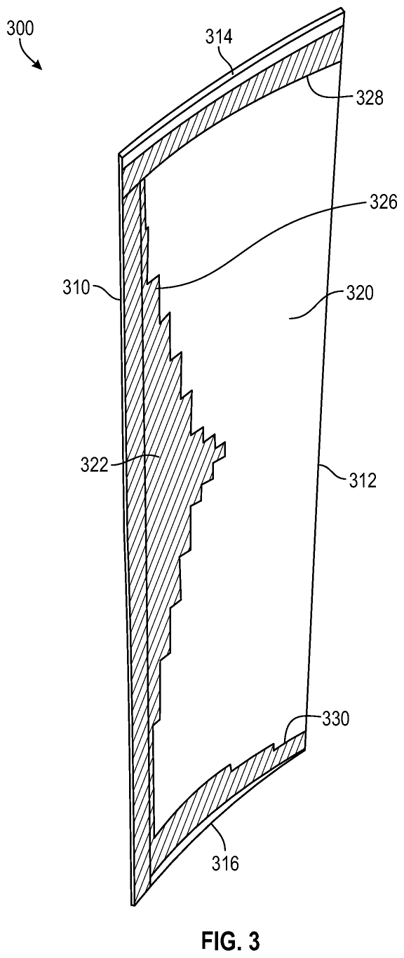

In the example of FIG. 3, the first edge 326 of the second stator vane 300 includes a triangular, stepped path or profile wherein a dimension of the leading portion is at a greatest at or near a midpoint between the radially outermost edge 314 and the radially innermost edge 316. From this point (e.g., the midpoint), dimensions of the leading portion measured between the radially leading edge 310 and the first edge 326 incrementally decrease toward both the radially outermost edge 314 and the radially innermost edge 316. Areas of the polymeric substrate 320 at or adjacent to a central region of the suction side wall and the trailing edge 312, as well as the pressure side wall of the second stator vane 300, are not covered by the metallic sheet 322.

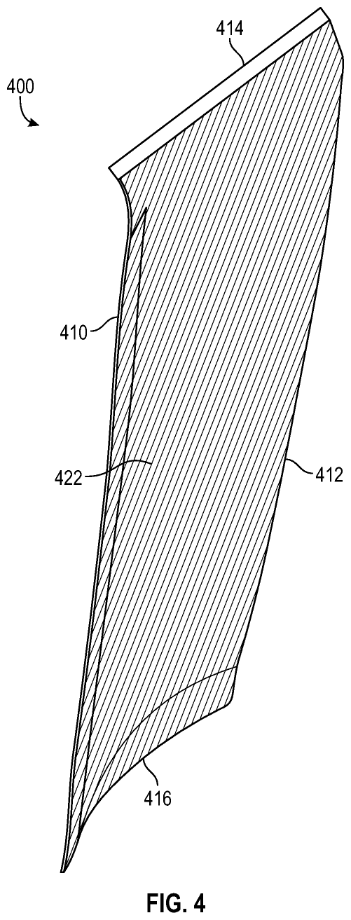

In the example of FIG. 4, the metallic sheet 422 covers an entirety or substantially an entirety of the suction side wall of the third stator vane 400. Areas of the polymeric substrate (not shown) on the pressure side wall of the third stator vane 400 are not covered by the metallic sheet 322.

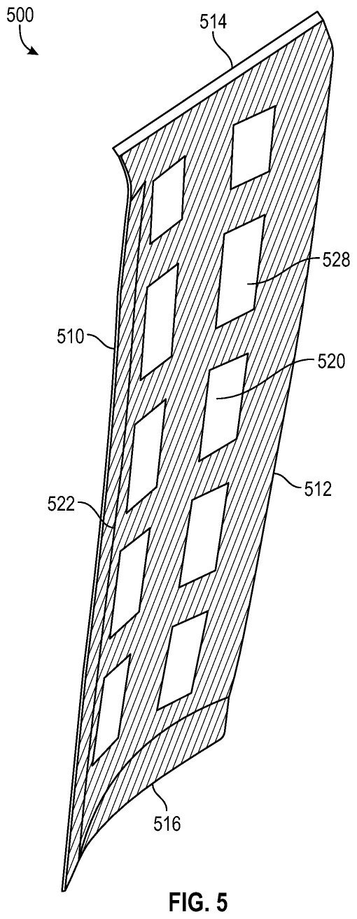

In the example of FIG. 5, the metallic sheet 522 extends across the suction side wall of the fourth stator vane 500 from the leading edge 510 to the trailing edge 512, and from the radially outermost edge 514 to the radially innermost edge 516. The metallic sheet 522 includes an array of openings defined therein by interior edges 528 that expose portions of the polymeric substrate 520. The openings may have various shapes and sizes, and may be the same as each other or may vary from each other in shape, size, and/or dimension. Further, the openings of the array may be aligned, may be equidistant from each other, may not be aligned, and/or may vary in distance therebetween. In the example of FIG. 5, the interior edges 528 are linear, the openings are rectangular, the openings are the same size as each other, and the openings are equidistant from each other. Areas of the polymeric substrate 520 on the pressure side wall of the second stator vane 500 are not covered by the metallic sheet 522.

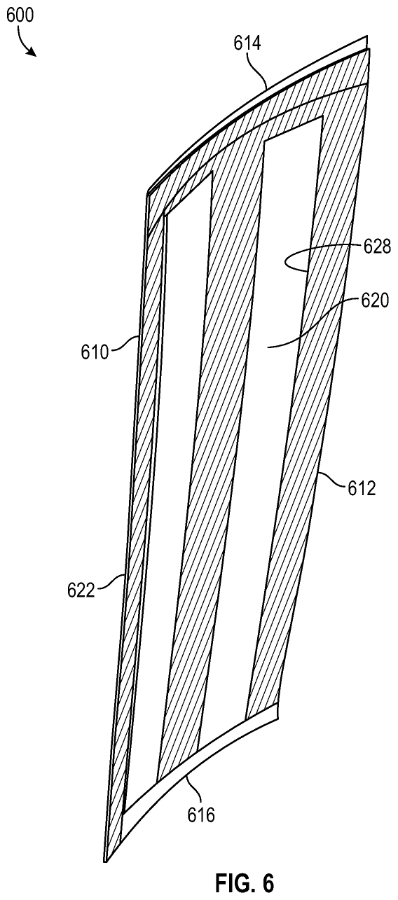

In the example of FIG. 6, the metallic sheet 622 covers areas of the polymeric substrate 620 on the suction side wall of the fifth stator vane 600, including areas at or adjacent to the leading edge 610 (i.e., the leading portion), the radially outermost edge 614 (i.e., the outer portion), the trailing edge 612 (referred to as the trailing portion of the metallic sheet 622), and along the central region (referred to as the central portion of the metallic sheet 622). Areas of the polymeric substrate 620 between the leading portion and the central portion, and between the central portion and the trailing portion, as well as certain areas along the pressure side of the fifth stator vane 600, are not covered by the metallic sheet 622. In other words, the interior edges 628 of the metallic sheet 622 are linear and define rectangular openings that are open at the radially innermost edge 616 of the fifth stator vane 600.

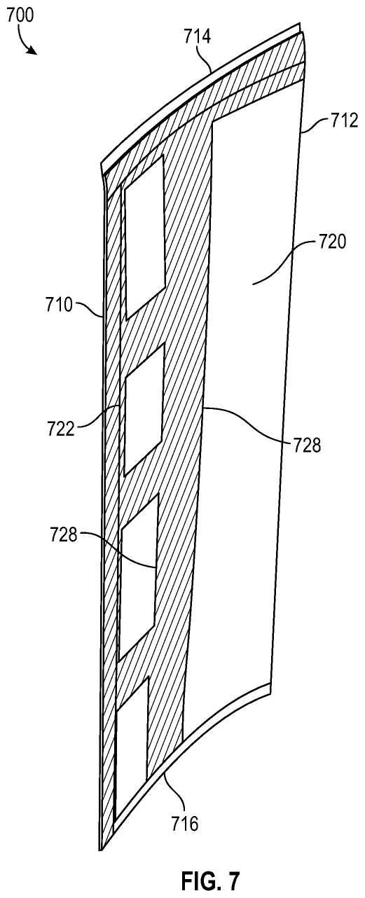

In the example of FIG. 7, the metallic sheet 722 covers areas of the polymeric substrate 720 on the suction side wall of the sixth stator vane 700, including areas at or adjacent to the leading edge 710 (i.e., the leading portion), the radially outermost edge 714 (i.e., the outer portion), and the along the central region (i.e., the central portion). In addition, the metallic sheet 722 covers certain areas between the leading portion and the central portion. Specifically, the interior edges 728 of the metallic sheet 722 between the leading portion and the central portion define an array of openings that expose portions of the polymeric substrate 720. In this example, the interior edges 728 are linear, the openings are rectangular, the openings are the same size as each other, and the openings are equidistant from each other. However, one of the openings closest to the radially innermost edge 716 is open at the radially innermost edge 716. Areas of the polymeric substrate 720 between the central portion and the trailing edge 712, as well as the pressure side of the sixth stator vane 700, are not covered by the metallic sheet 722.

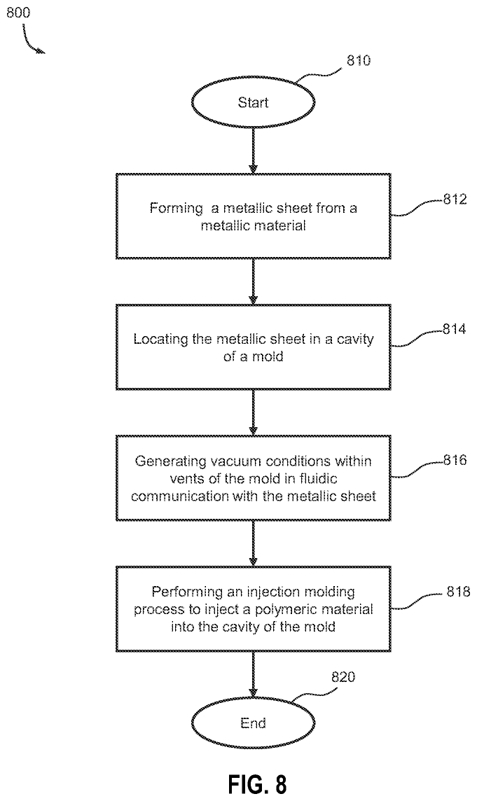

Various methods may be used to produce the stator vanes described herein, such as the stator vanes 200, 300, 400, 500, 600, and 700, for a gas turbine engine. As one nonlimiting example, FIG. 8 is a flowchart illustrating an exemplary method 800 for manufacturing a stator vane formed of a polymer-metal composite. The method 800 may start at 810.

At 812, the method 800 may include forming an entirety or a portion of the metallic sheet from a metallic material. Various methods may be used to form the metallic sheet. Various nonlimiting examples may include rolling and annealing processes, electroplating processes, chemical milling processes, laminating and bonding processes, metal powder sintering processes, hot and cold rolling processes, and sheet metal fabrication processes (e.g., shearing, bending, stamping, etc.). Nonlimiting metallic materials for the metallic sheet may include certain stainless steels, titanium alloys, aluminum alloys, and nickel-chromium alloys (e.g., Inconel®).

The method 800 may include forming an entirety or a portion of the polymeric substrate. Various methods may be used to form the polymeric substrate. In some examples, the polymeric substrate may be formed by an injection molding process. For example, a polymeric material or melt may be injected into a mold that includes a cavity corresponding to a predetermined shape of the polymeric substrate. Nonlimiting polymeric materials for the polymeric substrate may include various thermoplastic materials, such as certain nylon-based thermoplastic materials, polyether ether ketone (PEEK) materials, acrylic materials, polyester materials (e.g., polylactic acid), polypropylene materials, and acrylonitrile butadiene styrene (ABS) materials.

In various examples, the metallic sheet may be secured to the polymeric substrate subsequent to completion of the injection molding process. In other examples, the metallic sheet may be incorporated into the injection molding process. For example, the method 800 may include, at 814, locating the metallic sheet in the cavity of the mold. The mold may include one or more vents in fluidic communication with the metallic sheet. At 816, the method 800 may include generating low pressure or vacuum conditions within the one or more vents of the mold to produce a suction force that secures the metallic sheet against one or more interior walls of the mold. At 818, the method 800 may include performing the injection molding process to inject the polymeric material into the cavity of the mold and thereby form the polymeric substrate in fixed relation to the metallic sheet.

The method 800 may end at 820.

The systems and methods disclosed herein provide various benefits over certain existing systems and methods. For example, forming the stator vanes from the polymer-metallic composite materials described herein may reduce manufacturing costs and promote ease of manufacturing. For examples wherein the stator vanes are manufactured using injection molding processes, the stator vanes may be produced with improved adherence to the design tolerances and lower rejection rates while providing mechanical properties comparable to existing composite stator vanes (e.g., acceptable FOD loading behavior). In addition, the stator vanes may be produced with improved surface finishes relative to existing composite stator vanes. In some examples, the surface finishes may be comparable to machined level surface finishes compared to existing composite materials that typically have surface finishes comparable to cast components.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A stator vane, comprising:
a body configured to be installed in a bypass of a gas turbine engine such that the body impinges a gas flow within the gas turbine engine during operation thereof, the body having a suction side wall configured to face away from the incoming gas flow and an oppositely disposed pressure side wall configured to face towards the incoming gas flow, the body including a polymeric substrate formed of a polymer material and a metallic sheet formed of a metallic material, wherein the metallic sheet covers a portion of the polymeric substrate and is at least partially embedded in the polymeric substrate, wherein the polymeric substrate is formed by an injection molding process, wherein the metallic sheet defines at least part of but not an entirety of the pressure side wall or the suction side wall, wherein the metallic sheet includes a leading portion that covers the polymeric substrate adjacent to a leading edge of the body, an outer portion adjacent to a radially outermost edge of the body, and an inner portion adjacent to a radially innermost edge of the body, wherein the outer portion and/or the inner portion extend further from the leading edge toward a trailing edge of the body than the leading portion, wherein a central region of the body between the leading portion, outer portion, and the inner portion of the metallic sheet is defined by exposed portions of the polymeric substrate.

2. The stator vane of claim 1, wherein the body includes a hub end configured to couple with a hub of the gas turbine engine and an oppositely disposed shroud end configured to couple with a shroud of the gas turbine engine, wherein the metallic sheet is configured to promote decoupling of the hub end and the shroud end in response to foreign object damage (FOD) loading in excess of a threshold during operation of the gas turbine engine.

3. The stator vane of claim 1, wherein the polymeric substrate defines an entirety of the suction side wall and the metallic sheet defines at least part of the pressure side wall.

4. The stator vane of claim 1, wherein the polymeric substrate defines an entirety of the pressure side wall and the metallic sheet defines at least part of the suction side wall.

5. (canceled)

6. (canceled)

7. (canceled)

8. The stator vane of claim 24, wherein the metallic sheet covers at least a portion of a leading edge of the body, wherein the metallic sheet includes at least two interior edges that define one or more areas of the stator vane wherein the polymeric substrate is exposed.

9. The stator vane of claim 1, wherein a cross-sectional thickness of the body includes 90 to 95 weight percent of the polymeric substrate and 1 to 5 weight percent of the metallic sheet, wherein the metallic sheet has a thickness in the range of 127 to 229 micrometers.

10. (canceled)

11. A method of manufacturing a stator vane for a gas turbine engine, the method comprising:
forming a metallic sheet of a metallic material;
locating the metallic sheet in a cavity of a mold, wherein the mold includes one or more vents in fluidic communication with the metallic sheet;
generating low pressure or vacuum conditions within the one or more vents of the mold to generate a suction force on the metallic sheet and thereby secure the metallic sheet against an interior wall of the mold; and
performing an injection molding process to inject a polymeric material into the mold and thereby form a polymeric substrate that is fixed to the metallic sheet,
wherein the metallic sheet covers a portion of the polymeric substrate and is at least partially embedded in the polymeric substrate, and
wherein the polymeric substrate and the metallic sheet in combination define a body of the stator vane configured to be installed in a bypass of the gas turbine engine such that the body impinges a gas flow within the gas turbine engine during operation thereof, the body having a suction side wall configured to face away from the incoming gas flow and an oppositely disposed pressure side wall configured to face towards the incoming gas flow, wherein the polymeric substrate and the metallic sheet define an entirety of an airfoil of the body.

12. The method of claim 11, wherein the body includes a hub end configured to couple with a hub of the gas turbine engine and an oppositely disposed shroud end configured to couple with a shroud of the gas turbine engine, wherein the metallic sheet is configured to promote decoupling of the hub end and the shroud end in response to foreign object damage (FOD) loading in excess of a threshold during operation of the gas turbine engine.

13. The method of claim 11, wherein the polymeric substrate defines an entirety of the suction side wall and the metallic sheet defines at least part of the pressure side wall.

14. The method of claim 11, wherein the polymeric substrate defines an entirety of the pressure side wall and the metallic sheet defines at least part of the suction side wall.

15. The method of claim 11, wherein the metallic sheet defines less than an entirety of the pressure side wall or the suction side wall.

16. The method of claim 11, wherein the metallic sheet covers at least a portion of a leading edge of the body.

17. The method of claim 16, wherein the metallic sheet covers at least a portion of a trailing edge of the body.

18. The method of claim 16, wherein the metallic sheet includes at least two interior edges that define one or more areas of the stator vane wherein the polymeric substrate is exposed.

19. The method of claim 11, wherein a cross-sectional thickness of the body includes about 90 to about 95 weight percent of the polymeric substrate and about 1 to 5 weight percent of the metallic sheet.

20. The method of claim 11, wherein the metallic sheet has a thickness in the range of 127 to 229 micrometers.

21. The stator vane of claim 1, wherein the leading portion has greater first axial dimension adjacent to a midpoint between the outermost edge and the innermost edge of the body than a second axial dimension adjacent to the outermost edge or the innermost edge of the body.

22. The stator vane of claim 1, wherein the leading portion varies in an axial dimension, or the inner portion varies in a radial dimension.

23. The stator vane of claim 22, wherein the leading portion and/or the inner portion include an interior edge having a step pattern.

24. A stator vane, comprising:
a body configured to be installed in a bypass of a gas turbine engine such that the body impinges a gas flow within the gas turbine engine during operation thereof, the body having a suction side wall configured to face away from the incoming gas flow and an oppositely disposed pressure side wall configured to face towards the incoming gas flow, the body having an airfoil consisting of a polymeric substrate formed of a polymer material and a metallic sheet formed of a metallic material, wherein the metallic sheet covers a portion of the polymeric substrate and is at least partially embedded in the polymeric substrate, wherein the polymeric substrate is formed by an injection molding process.
